(19) United States
(12) Patent Application Publication
(10) Pub. No.: US 2026/0304208 A1
(43) Pub. Date: Oct. 1, 2026

(54) QoS FLOW CONTROL METHOD AND APPARATUS AND COMPUTER STORAGE MEDIUM

(71) Applicant: Beijing Xiaomi Mobile Software Co., Ltd., Beijing (CN)

(72) Inventors: Jin Hua WU, Beijing (CN); Yang SHEN, Beijing (CN); De Qian WANG, Beijing (CN); Jian Ning LIU, Beijing (CN); Yu Xin MAO, Beijing (CN)

(21) Appl. No.: 18/879,095

(22) PCT Filed: Jun. 30, 2022
(86) PCT No.: PCT/CN2022/102943

§ 371 Date: Dec. 26, 2024

(51) Int. Cl. H04W 28/02

(52) U.S. Cl. CPC H04W 28/0268

(57) ABSTRACT

A Quality of Service (QoS) flow control method includes: receiving, by a first core network function entity, terminal status information from a second core network function entity, wherein the terminal status information indicates a power consumption state of a terminal; and updating, by the first core network function entity, a QoS parameter of a QoS flow according to the terminal status information.

### CROSS REFERENCE TO RELATED APPLICATIONS

This application is a US National Stage of International Application No. PCT/CN2022/102943, filed on Jun. 30, 2022, the disclosure of which is incorporated herein by reference in its entirety.

### TECHNICAL FIELD

The present disclosure relates to the field of wireless communications, and in particular, to a QoS flow control method and apparatus, and a computer storage medium.

### BACKGROUND

In the 5th generation mobile networks (5G) technology, mobile media services, cloud extend reality (XR), cloud games, video-based machines or unmanned aerial vehicle (UAV) remote control are expected to contribute more and more traffic to 5G networks.

### SUMMARY

The present disclosure provides a QoS flow control method, apparatus, and computer storage medium to match service traffic characteristics and terminal power consumption management, thereby ensuring service requirements and user experience.

According to a first aspect of the disclosure, a Quality of Service (QoS) flow control method is provided, which may be performed by a first core network function entity in a communication system, such as a policy control function (PCF) entity. The method may include: receiving, by a first core network function entity, terminal status information from a second core network function entity, where the terminal status information indicates a power consumption state of a terminal; updating, by the first core network function entity, a QoS parameter of a QoS flow according to the terminal status information.

In some examples, the QoS flow is a guaranteed bit rate (GBR) QoS flow, and a QoS parameter of the QoS flow includes a guaranteed flow bit rate (GFBR) and/or a maximum flow bit rate (MFBR).

In some examples, the first core network function entity updating a QoS parameter of a QoS flow according to the terminal status information, includes: decreasing or increasing, by the first core network function entity, the GFBR according to the terminal status information.

In some examples, the method further includes: sending, by the first core network function entity, an MFBR to a third core network function entity, where the MFBR is used by the third core network function entity to update a QoS parameter of a downlink GBR QoS flow; and/or sending, by the first core network function entity, an MFBR to an access network function entity, where the MFBR is used by the access network function entity to update a QoS parameter of an uplink and/or downlink GBR QoS flow.

In some examples, the QoS flow is a non-GBR QoS flow, and a QoS parameter of the QoS flow includes an aggregated maximum bit rate (AMBR).

In some examples, the first core network function entity updating the QoS parameter of the QoS flow according to the terminal status information includes: decreasing or increasing, by the first core network function entity, the AMBR according to the terminal status information.

In some examples, the AMBR includes at least one of: an AMBR per terminal, an AMBR per session, and
the method further includes at least one of:
sending, by the first core network function entity, an AMBR per session to a third core network function entity, where the AMBR per session is used by the third core network function entity to update a QoS parameter of an uplink and/or downlink session QoS flow;
sending, by the first core network function entity, the AMBR per session to the terminal, where the AMBR per session is used by the terminal to perform uplink rate limitation on packet data unit (PDU) session basis for the non-GBR QoS flow; or
sending, by the first core network function entity, an AMBR per terminal to an access network function entity, where the AMBR per terminal is used by the access network function entity to update a QoS parameter of an uplink and/or downlink non-GBR QoS flow of each terminal.

In some examples, the QoS flow is a GBR QoS flow or a non-GBR QoS flow, and a QoS parameter of the QoS flow includes a maximum bit rate (MBR) per slice per terminal.

In some examples, in response to the QoS parameter including an MBR per slice per terminal, the method further includes: sending, by the first core network function entity, the MBR per slice per terminal to an access network function entity, where the MBR per slice per terminal is used by the access network function entity to update a QoS parameter of a PDU session QoS flow corresponding to a single network slice selection assistance information (S-NSSAI) of the terminal.

In some examples, the receiving, by a first core network function entity, terminal status information from a second core network function entity includes: sending, by the first core network function entity, a subscription request message to the second core network function entity, where the subscription request message is used to request a first event associated with the terminal status information; in a case that the first event meets an event reporting condition, receiving, by the first core network function entity, the terminal status information sent by the second core network function entity.

According to a second aspect of the present disclosure, there is provided a Quality of Service (QoS) flow control method, which may be performed by a second core network function entity such as an SMF entity in a communication system. The method includes: receiving, by a second core network function entity, terminal status information from a terminal, where the terminal status information indicates a power consumption state of the terminal; performing, by the second core network function entity, one of: updating, by the second core network function entity, a QoS parameter of a QoS flow according to the terminal status information; sending, by the second core network function entity, the terminal status information to a first core network function entity, where the terminal status information is further used by the first core network function entity to determine a QoS parameter of a QoS flow.

In the present disclosure, the second core network function entity may be an SMF entity, and the first core network function entity is a PCF entity.

In some examples, the QoS flow is a guaranteed bit rate (GBR) QoS flow, and the QoS parameter of the QoS flow includes a guaranteed flow bit rate (GFBR) and/or a maximum flow bit rate (MFBR).

In some examples, in response to the QoS parameter including the MFBR, the method further includes: receiving, by the second core network function entity, an MFBR sent by the first core network function entity; sending, by the second core network function entity, the MFBR to a third core network function entity, where the MFBR is used by the third core network function entity to update a QoS parameter of a downlink GBR QoS flow.

In some examples, the QoS flow is a non-GBR QoS flow and the QoS parameter of the QoS flow includes an aggregated maximum bit rate (AMBR).

In some examples, the AMBR includes at least one of: an AMBR per terminal, an AMBR per session.

In some examples, in response to the AMBR including an AMBR per session, the method further includes: receiving, by the second core network function entity, an AMBR per session sent by the first core network function entity; sending, by the second core network function entity, the AMBR per session to a third core network function entity, where the AMBR per session is used by the third core network function entity to update a QoS parameter of an uplink and/or downlink session QoS flow.

In some examples, the receiving, by a second core network function entity, terminal status information includes: receiving, by the second core network function entity, the terminal status information sent by the terminal, where the terminal status information is carried in a non-access stratum (NAS) parameter.

In some examples, the terminal status information is carried in a protocol configuration option (PCO) parameter or a parameter of 5GSM core network capability of the terminal (UE 5GSM Core Network Capability).

In some examples, the receiving, by a second core network function entity, terminal status information includes: receiving, by the second core network function entity, the terminal status information sent by an access network function entity, where the terminal status information is extracted from an access network (AN) parameter and added to an NAS parameter by the access network function entity.

In some examples, the method further includes: performing, by the second core network function entity, static rule activation and QoS authorization update according to the QoS parameter.

In some examples, the sending, by the second core network function entity, the terminal status information to a first core network function entity includes: querying, by the second core network function entity, event subscriptions, and confirming that a first event associated with the terminal status information is subscribed to; in a case that an event reporting condition is met, sending, by the second core network function entity, the terminal status information to the first core network function entity.

In some examples, the sending, by the second core network function entity, the terminal status information to the first core network function entity includes: sending, by the second core network function entity, the terminal status information to the first core network function entity according to subscription data of the terminal and/or an operator policy.

According to a third aspect of the present disclosure, a communication device, such as a first core network function entity, is provided. The communication device may include a memory and a processor; where the processor is connected to the memory and configured to, by executing computer-executable instructions stored on the memory, perform operations including: receiving terminal status information from a second core network function entity, wherein the terminal status information indicates a power consumption state of a terminal; updating a QoS parameter of a QoS flow according to the terminal status information.

According to a fourth aspect of the present disclosure, there is provided a non-transitory computer-readable storage medium storing instructions, when the instructions are executed by a computer, the computer is caused to perform the QoS flow control method as according to the first to second aspects.

It should be understood that the third to fourth aspects of the present disclosure are consistent with the technical solutions of the first to second aspects of the present disclosure, and the advantages achieved by each aspect and the corresponding feasible examples are similar, which will not be described again.

### BRIEF DESCRIPTION OF DRAWINGS

FIG. 1 is a schematic diagram of an architecture of a 5G communication system according to an example of the present disclosure.

FIG. 2 is a schematic flowchart illustrating an implementation of a first QoS flow control method for according to an example of the present disclosure.

FIG. 3 is a schematic flowchart illustrating an implementation of performing a QoS update on a GBR QoS flow according to an example of the present disclosure.

FIG. 4 is a schematic diagram of an implementation flow of performing a QoS update on a non-GBR QoS flow according to an example of the present disclosure.

FIG. 5A is a schematic flowchart illustrating an implementation of a second QoS flow control method according to an example of the present disclosure.

FIG. 5B is a schematic flowchart illustrating an implementation of a third QoS flow control method according to an example of the present disclosure.

FIG. 6 is a schematic diagram of a structure of a QoS flow control apparatus according to an example of the present disclosure.

FIG. 7 is a schematic structural diagram of a communication apparatus according to according to an example of the present disclosure.

FIG. 8 is a schematic structural diagram of a network function entity according to an example of the present disclosure.

### DETAILED DESCRIPTION

Reference will now be made in detail to the exemplary embodiments, examples of which are illustrated in the accompanying drawings. When the following description refers to the drawings, the same numbers in different drawings indicate the same or similar elements, unless otherwise indicated. The examples described in the following examples are not intended to represent all implementations that are consistent with the examples of the present disclosure. Rather, they are merely examples of apparatus and methods consistent with some aspects of the examples of the present disclosure as detailed in the appended claims.

The terms used in the examples of the disclosure are for the purpose of describing particular examples only and are not intended to limit the examples of the present disclosure. As used in the examples of the present disclosure and the append claims, the singular forms “a”, “an”, and “the” are intended to include the plural form as well, unless the context clearly dictates otherwise. It should also be understood that the term “and/or” as used herein refers to and encompasses any and all possible combinations of one or more of the associated listed items.

It should be understood that although the terms “first”, “second”, “third”, etc. may be employed in examples of the present disclosure to describe various information, the information should not be limited to these terms. These terms are used only to distinguish one type of information from another. For example, “first information” may also be referred to as “second information”, and similarly, “second information” may also be referred to as “first information” without departing from the scope of examples of the present disclosure. Depending on the context, the word “if” as used herein may be interpreted as “where . . . ” or when . . . ” or “in response to a determination that”.

Further, in the description of the examples of the present disclosure, “and/or” is only a description of the association relationship between associated objects, indicating that there may be three kinds of relationships. For example, A and/or B may represent: A alone, A and B together, and B alone. Additionally, in the description of the examples of the present disclosure, “a plurality” may refer to two or more than two.

At present, because XR and media services have the characteristics of high throughput, requirements of low latency and high reliability, the terminal side requires high power consumption, and the battery power of the terminal may affect the user experience.

Then, how to match the traffic characteristics and terminal power consumption management is an urgent problem to be solved.

The technical scheme of the examples of the present disclosure relates to a communication system architecture. The communication system may be a 5G communication system or a future evolution communication system. In the architecture of the communication system, there are a terminal, an access network function entity (which may also be described as an access network function entity, an access network element, an access network function component, an access network function module, etc.), and at least one core network function (NF) entity (which may also be described as a core network device, a core network element, a core network functional component, or a core network functional module). At least one core network function entity is located in the core network (i.e., 5GC). The terminal is used for reporting the UE status information (terminal status information) used for indicating the power consumption state of the terminal to the core network. The at least one core network function entity at least has the following functions: according to the received UE status information, performing QoS update on the QoS flow. In practical applications, the QoS flow is a QoS flow of a first service of the terminal. The first service may include an XR service, a mobile media service, etc., where the XR service and the mobile media service may also be referred to as an XRM service, or may be described as an XR\M service.

Hereinafter, the examples of the present disclosure will be explained and illustrated by taking a 5G communication system as an example. It should be noted that the examples of the present disclosure are also applicable to any future evolution communication system after the 5G communication system, which is not specifically limited in the examples of the present disclosure.

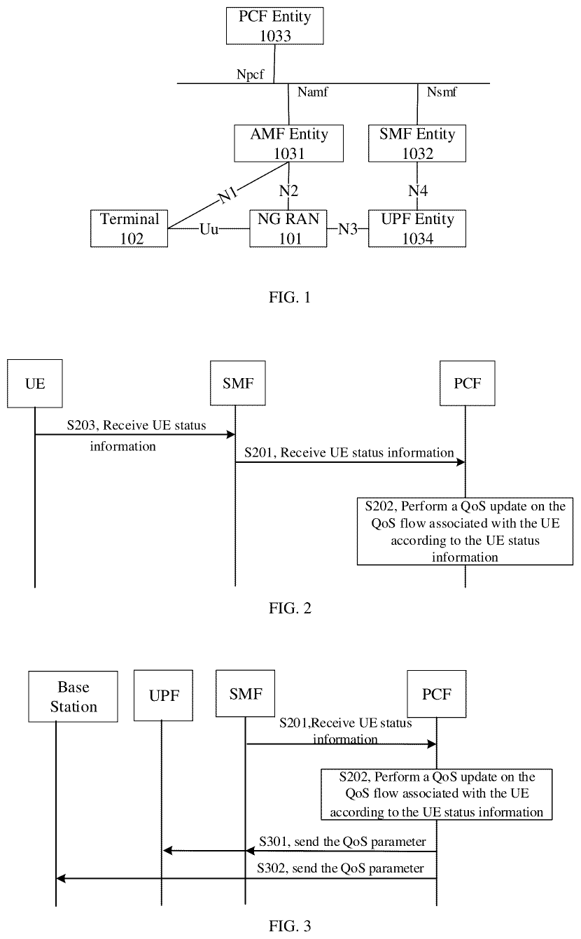

FIG. 1 is a schematic diagram of an architecture of a 5G communication system according to an example of the present disclosure. Referring to FIG. 1, the 5G communication system 100 may include a 5G radio access network (RAN) and a 5G core network (5GC). The 5G radio access network may include a next generation radio access network (NG RAN). The NG RAN 101 communicates with the terminal (or referred to as a terminal equipment) 102 through a Uu interface. The 5G core network may include the at least one core network function entity, such as an access and mobility management function (AMF) entity 1031, an SMF entity 1032, a PCF entity 1033, and a UPF entity 1034, etc. In examples of the present disclosure, the communication system may further include other network function entities (which may also be referred to as network elements, network devices, etc.), which is not specifically limited in the examples of the present disclosure.

In order to make the descriptions more concise, in the subsequent description, the “entity” in each function entity is removed, for example, a PCF entity is called a PCF for short, and an SMF entity is called an SMF for short. Other entities are similar and will not be listed one by one.

In the example of the present disclosure, in the 5G communication system 100, the following interfaces may be set between the core network function entities.
N3: A communication interface between UPF 1034 and NG RAN 101.
N4: An interface between the SMF 1032 and the UPF 1034, configured to transmit information between a control plane and a user plane (UP), including the issuing of forwarding rules from the control plane to the UP, QoS control rules, traffic statistics rules, etc., and reporting of UP information.
N2: An interface between the AMF 1031 and the NG RAN 101, configured to transfer radio bearer control information and the like from the core network side to the NG RAN 101.
N1: An interface between the AMF 1031 and the terminal 102, which is unrelated to access and is configured to transmit QoS control rules and the like to the terminal 102.

In FIG. 1, the communications between any two entities among the PCF, the AMF, and the SMF may adopt a service-oriented communication manner. For example, the interfaces Namf and Npcf adopted for the communications between the AMF and the PCF are both service-oriented interfaces, and similarly, the interface Nsmf is also a service-oriented interface.

The terminal may be a terminal equipment with a wireless communication function and a wireless sensing function, and may also be referred to as a user equipment (UE). The terminal may be deployed on land, including being indoor or outdoor, handheld, wearable or vehicle-mounted; it can also be deployed on water (such as on ships); it can also be deployed in the air (such as on airplanes, balloons and satellites, etc.). The terminal may be a mobile phone, a tablet computer, a computer with a wireless transceiving function, a virtual reality (VR) terminal equipment, an augmented reality (AR) terminal equipment, a wireless terminal in industrial control, a wireless terminal in self-driving, a wireless terminal in telemedicine, a wireless terminal in smart grid, a wireless terminal in transportation safety, a wireless terminal in a smart city, a wireless terminal in a smart home, and the like. The terminal may also be a handheld equipment, a vehicle-mounted equipment, a wearable equipment, a computing equipment with a wireless communication function and a wireless sensing function or other processing equipment connected to a wireless modem. In some examples, the terminal equipment may be called different names in different networks, e.g., a terminal equipment, an access terminal, a subscriber unit, a subscriber station, a mobile station, a mobile platform, a remote station, a remote terminal, a mobile equipment, a user terminal, a terminal, a wireless communication equipment, a user agent or user equipment, a cellular phone, a cordless phone, a session initiation protocol (SIP) phone, a wireless local loop (WLL) station, a personal digital assistant (PDA), a terminal in a 5G communication system or a future evolution communication system, and the like.

The access network function entity may be a function entity at the access network side and for supporting the access of a communication terminal to the wireless communication system, for example, a next generation NodeB (gNB) in a 5G communication system, a transmission reception point (TRP), a relay node, an access point (AP), and the like.

It should be noted that, in the communication system shown in FIG. 1, each function entity and interface are only for examples, and when each function entity is applied to the examples of the present disclosure, not all functions of the function entities are necessary. A function entity of the access network and the core network may be a physical entity device or a virtualized device, which is not limited herein. The communication system in the examples of the present disclosure may further include other devices not shown in FIG. 1, which is not limited herein.

In 5G networks, mobile media services, XR, cloud games, video-based machines or unmanned aerial vehicle (UAV) remote control, etc., are expected to contribute more and more traffic to 5G networks, especially XR and extend reality and media (XRM) service. The XRM service has the characteristics of high throughput, requirements of low latency and high reliability, which requires high power consumption on the terminal side, and the battery power of the terminal may affect the user experience.

At present, based on the existing terminal implementation, considering the traffic characteristics, a scheme for enhancement of power saving for a terminal has been defined in 3GPP. For example, the power saving modes of a terminal in different connection management (CM) states, such as a power saving mode of CM-IDLE (idle state) and a power saving mode of CM-CONNECTED (connected) in an RRC inactive state. A mobile initiated connection only (MICO) mode, and an extended DRX (eDRX) mode, etc. are also defined. However, the above schemes are specially designed for the Internet of Things (IoT) terminals with ultra-low power consumption. If these schemes are used on smartphones, the user experience will be greatly affected.

Therefore, the matching of the traffic characteristics and terminal power consumption management is an urgent problem to be solved.

In the examples of the present disclosure, the third core network function entity may be a user plan function (UPF) entity, in the following examples, the terminal equipment in the communication system may take a UE as an example, the access network function entity may take a base station as an example, the first core network function entity may take a PCF as an example, the second core network function entity may take another PCF as an example, the third core network function entity may take a UPF as an example, and the application function entity may take an application function entity (AF) as an example for explaining the QoS flow control method proposed in the examples of the present disclosure. In the 5G communication system and its evolved versions, the terminal, the access network function entity, the first core network function entity, the second core network function entity, the third core network function entity and the application function entity may also be other function entities with the same or similar functions and connections, which is not limited in the examples of the present disclosure.

In order to solve the above problem, in conjunction with the above communication system, an example of the present disclosure provides a QoS flow control method.

In the above communication system, the following two scenarios may exist, which is not limited.

In the first scenario, a PCF is deployed in the communication system. The PCF performs QoS control on the QoS flow according to the terminal status information. In this architecture, the PCF 1033 connected to the AMF 1031 and the SMF 1032 may correspond to a PCF for access and mobility control (AM PCF) and a PCF for session management (SM PCF) separately. In an actual deployment scenario, the AM PCF and the SM PCF may not be a same PCF entity.

In the second scenario, the communication system is not deployed with a PCF. At this time, the SMF performs static rule activation and QoS authorization update according to the QoS parameter.

In some examples, with respect to the first scenario, FIG. 2 is a schematic flowchart illustrating an implementation of a first QoS flow control method according to an example of the present disclosure. As shown in FIG. 2, in this example, the QoS flow control method is applied to the first core network function entity (for example, a PCF) side. The QoS flow control method may include S201 to S202.

In S201, the first core network function entity (for example, a PCF) receives terminal status information (UE status information) sent from the second core network function entity (for example, an SMF).

Where the UE status information is used for representing the power consumption state of the UE. For example, the UE status information includes one or more parameters related to the UE performance. For example, the UE status information may include at least one of a UE battery level, a UE battery life, a powered mode of the UE, a CPU load of the UE, and a UE overheating status. In the examples of the present disclosure, the parameters related to the power consumption of the UE may include others. Here the powered mode of the UE may include a battery-powered mode and a mains/wall-powered mode. Here, the battery-powered mode means that a built-in battery of the UE is used for power supply, and the mains/wall-powered mode means that a power adapter is used to connect to a wall socket, a mobile socket, or the like to connect the UE to a power supply for supplying power to the UE.

It should be understood that the UE may send its own UE status information to the SMF, and the SMF send the UE status information to the PCF.

In some examples, the SMF may perform S203 before S201.

In S203, the SMF receives the UE status information sent by the UE.

In an example, the SMF may, but is not limited to, obtain the UE status information sent by the UE in the following manners.

In the first manner, the execution of S201 is not affected by the access network (without RAN impact). In this case, the UE carries the UE status information in a NAS parameter and sends it to the access network function entity (such as a base station), and the base station forwards the NAS parameter to the SMF via the AMF. For example, the UE status information may be carried in a NAS parameter such as a PCO parameter and a parameter of UE 5GSM Core Network Capability, etc.

In the second manner, the execution of S201 is influenced by the access network (with RAN impact). In this case, the UE carries the UE status information in an AN parameter and sends it to the access network function entity (such as a base station), and the base station extracts the UE status information from the AN parameter and carries it in a NAS parameter and forwards it to the SMF via the AMF.

In some examples, in S201, the SMF needs to determine whether the PCF needs the UE status information of the UE, and if so, the SMF sends the UE status information to the PCF. For example, if subscription information of the UE needs to include the UE status information, the SMF may provide the PCF with the UE status information of the UE. Here, the subscription information is downloaded by the SMF from a unified data management (UDM) function entity.

In some examples, the PCF may further send a subscription request message to the SMF to subscribe to an event associated with the UE status information (that is, UE status information event), which is a first event. In S201, after receiving the UE status information of the UE, the SMF may query the event subscriptions and confirm that the PCF has subscribed to the first event; in a case that an event reporting condition is met, the SMF sends the UE status information to the PCF. For example, the event reporting condition may be a UE status change, various network policies of the first service and/or reaching of a threshold in the network configuration, powered mode matched, immediate reporting at receiving, periodic reporting, and the like. The event reporting condition may also include other conditions, which is not specifically limited in the example of the present disclosure.

In S202, the PCF performs a QoS update on the QoS flow associated with the UE according to the UE status information.

It can be understood that after receiving the UE status information of the UE, the PCF may perform a QoS update on the QoS flow associated with the UE according to the power consumption state of the UE.

Here, the QoS flow associated with the UE may be related to the first service. In the examples of the present disclosure, the first service may be an XRM service or an XRM service group.

In some examples, the QoS flow may be of different granularities, for example, it may be session oriented (i.e., session QoS flow) or service oriented (e.g., service data flow QoS flow), which is not specifically limited in the examples of the present disclosure.

It can be understood that the PCF may determine the corresponding QoS parameters for one or more sessions of one service (i.e., the first service) of the UE according to the UE status information. In some examples, the PCF may determine the corresponding QoS parameters for one service (i.e., the first service) of the UE according to the UE status information. Here, “determine” may be described as “set”, “generate”, “update”, etc.

In some examples, the QoS flow may be a GBR QoS flow and a non-GBR QoS flow. For different types of QoS flows, the corresponding QoS parameters are also different. For example, if the QoS flow is a GBR QoS flow, the QoS parameter of the QoS flow may include a GFBR and/or an MFBR. If the QoS flow is a non-GBR QoS flow, the QoS parameter of the QoS flow may include an AMBR. The AMBR can be divided into AMBR per terminal (UE-AMBR) and AMBR per session (Session-AMBR) according to different granularities.

In an example, if the QoS flow is a GBR QoS flow or a non-GBR QoS flow, the QoS parameter of the QoS flow may further include an MBR per session per terminal (UE-session-MBR).

In some examples, in a case that the QoS flow associated with the UE is a GBR QoS flow, S202 may include the PCF decreasing or increasing one or more of the GFBR and the MFBR according to the UE status information, so as to perform a QoS update on the GBR QoS flow.

In some examples, FIG. 3 is a schematic flowchart of an implementation of performing a QoS update on a GBR QoS flow according to an example of the present disclosure. Referring to FIG. 3, after the PCF performs the QoS update by executing S202, the PCF may further execute at least one of S301 and S302.

In S301, the PCF sends a QoS parameter (such as a GFBR and/or an MFBR) to the UPF entity, where the QoS parameter is used for the UPF to perform a QoS update on a downlink GBR QoS flow.

It can be understood that the PCF may send the QoS parameter to the SMF through the Npcf and the Nsmf, and then the SMF sends the QoS parameter to the UPF. After receiving the QoS parameter, the UPF uses the QoS parameter to perform a QoS update on the downlink GBR QoS flow.

In S302, the PCF sends the QoS parameter to the base station, and the QoS parameter is used for the base station to perform a QoS update on the uplink and/or downlink GBR QoS flow.

It can be understood that the PCF may send the QoS parameter to an AMF through the Npcf and the Namf, and then the AMF sends the QoS parameter to the base station. After receiving the QoS parameter, the base station uses the QoS parameter to perform a QoS update on the uplink and/or downlink GBR QoS flow.

In the S301 and S302, the AMF and the SMF may also obtain the QoS parameter sent by the PCF by subscribing to an event. For example, the AMF may subscribe to the PCF for the event associated with the QoS parameter. After determining the QoS parameter, the PCF queries the event subscriptions and confirms the event associated with the QoS parameter. When the event meets a reporting condition, the PCF sends the QoS parameter to the AMF. Similarly, the SMF may also subscribe to the PCF for the event associated with the QoS parameter. After determining the QoS parameter, the PCF queries the event subscriptions and confirms the event associated with the QoS parameter. The PCF sends the QoS parameter to the SMF in a case that the event meets a reporting condition. The AMF and the SMF may also obtain the QoS parameter from the PCF in other ways, which is not specifically limited in the examples of the present disclosure.

In some examples, in a case that the QoS flow is a non-GBR QoS flow, S202 may further include the PCF decreasing or increasing the AMBR according to the UE status information, so as to perform a QoS update on the non-GBR QoS flow. For example, the UE status information indicates that the temperature of the UE is too high to meet the current bandwidth requirement, the PCF reduces the Session-AMBR of the first service of the UE.

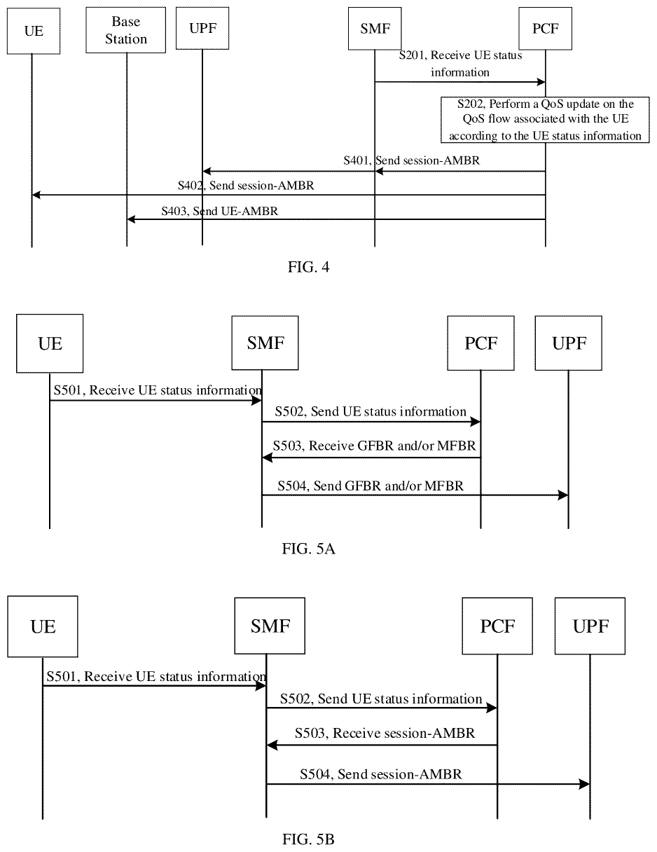

In some examples, FIG. 4 is a schematic flowchart of an implementation of performing a QoS update on a non-GBR QoS flow according to an example of the present disclosure. Referring to FIG. 4, for different QoS parameters, after S202, the PCF may further perform at least one of S401 to S403.

In S401, the PCF sends the session-AMBR to the UPF, so that the UPF uses the session-AMBR to perform a QoS update on the uplink and/or downlink session QoS flow. Here, the PCF sends the session-AMBR to the SMF first, and then the SMF sends it to the UPF.

In S402, the PCF sends the session-AMBR to the UE, so that the UE performs uplink rate limitation on PDU session basis for the non-GBR QoS flow.

In S403, the PCF sends the UE-AMBR to the base station, so that the base station performs a QoS update on the uplink and/or downlink non-GBR QoS flow of each UE.

For a GBR QoS flow, the PCF may further perform other QoS updates, which is not specifically limited in the examples of the present disclosure.

In some examples, the QoS flow is a GBR QoS flow or a non-GBR QoS flow, and the QoS parameter of the QoS flow includes an MBR per slice per terminal (UE-slice-MBR).

In some examples, after the S202, the method includes: the PCF sending a UE-slice-MBR to the base station, so that the base station performs a QoS update on a PDU session QoS flow corresponding to an S-NSSAI of the UE. The S-NSSAI is used for identifying a network slice.

It should be understood that the UE may correspond to one or more PDU sessions on one slice, and the one or more PDU sessions are sessions of the first service. After receiving the UE-Slice-MBR, the base station performs a QoS update on the UE's QoS flows for all sessions of the first service on the slice corresponding to the S-NSSAI by using the UE-Slice-MBR.

It should be noted that whenever a request for GBR QoS flow establishment or modification is received, the base station admission control should ensure that the sum of the GFBR values of the admitted GBR QoS flows does not exceed the UE-Slice-MBR, and if the QoS flow cannot be admitted, the base station should reject the establishment or modification of the QoS flow. And the base station should ensure that the aggregated bit rate across all GBR and non-GBR QoS flows belonging to PDU sessions corresponding to the S-NSSAI of the UE does not exceed the UE-Slice-MBR, while always ensuring the GFBR of each GBR QoS flow of these PDU sessions.

In the above process, if S202 is a QoS update process, the QoS parameter sent by the PCF may be an updated QoS parameter.

Through the above process, the PCF completes the process of performing QoS control based on the UE status information.

At this point, the process of a PCF controlling a QoS flow in the first scenario is implemented.

It should be noted that the QoS control process may be multiplexed with a PDU session establishment procedure, etc. It can also be multiplexed with other processes, which is not specifically limited in the example of the present disclosure.

In some examples, an example of the present disclosure further provides a QoS flow control method, which is applied in the first scenario. FIG. 5A is a schematic flowchart illustrating an implementation of a second QoS flow control method according to an example of the present disclosure. Referring to FIG. 5A, the QoS flow control method may be applied to the second core network function entity (for example, an SMF) side, and the QoS flow control method may include S501-S503.

In S501, the second core network function entity (for example, an SMF) receives UE status information sent by the UE.

Where the UE status information represents the power consumption state of the UE.

In some examples, the SMF may, but is not limited to, obtain the UE status information sent by the UE in the following manners.

In the first manner, the execution of S501 is not affected by the access network (without RAN impact). In this case, the UE carries the UE status information in an NAS parameter and sends it to the access network function entity (such as a base station), and the base station forwards the NAS parameter to the SMF via the AMF. For example, the UE status information may be carried in an NAS parameter such as a PCO parameter and a parameter of UE 5GSM Core Network Capability, etc.

In the second manner, the execution of S501 is influenced by the access network (with RAN impact). In this case, the UE carries the UE status information in a AN parameter and sends it to the access network function entity (such as a base station), and the base station extracts the UE status information from the AN parameter and carries it in an NAS parameter and forwards it to the SMF via the AMF.

In some examples, for the first scenario, the SMF performs S502 after S501.

In S502, the SMF sends the UE status information to the PCF.

Where the UE status information is further used for the PCF to perform a QoS update on a QoS flow associated with the UE.

In some examples, in S201, the SMF needs to determine whether the PCF needs the UE status information of the UE, and if so, the SMF sends the UE status information to the PCF. For example, if the subscription information of the UE needs to include UE status information, the SMF may provide the PCF with the UE status information of the UE. Here, the subscription information is downloaded by the SMF from a UDM function entity.

In some examples, the PCF may further send a subscription request message to the SMF to subscribe to an event associated with the UE status information (that is, UE status information event), which is a first event. After S501, after receiving the UE status information of the UE, the SMF may query the event subscriptions and confirm that the PCF has subscribed to the first event; in a case that an event reporting condition is met, the SMF performs S502 to send the UE status information to the PCF. For example, the event reporting condition may be a UE status change, various network policies of the first service and/or reaching of a threshold in the network configuration, powered mode matched, immediate reporting at receiving, periodic reporting, and the like. The event reporting condition may also include other conditions, which is not specifically limited in the example of the present disclosure.

In some examples, still referring to FIG. 5A, if the QoS flow is a GBR QoS flow, after S502, the SMF may further perform S503 to S504.

In S503, the SMF receives a QoS parameter (such as a GFBR and/or an MFBR) sent by the PCF.

In S504, the SMF sends the QoS parameter to the third core network function entity (such as a UPF), so that the UPF performs a QoS update on a downlink GBR QoS flow.

It should be understood that when executing S301, the PCF may send the GFBR and/or MFBR to the SMF, and the SMF sends the GFBR and/or MFBR to the UPF, so that the UPF performs a QoS update on the downlink GBR QoS flow.

It should be noted that the execution processes of S503 can be referred to the description of S301 in the examples of FIG. 2 to FIG. 3, which are not described here.

In other examples, still referring to FIG. 5A, if the QoS flow is a non-GBR QoS flow, after S502, the SMF may further execute S505 and S506, which are not shown in FIG. 5A.

In S505, the SMF receives a QoS parameter (for example, a session-AMBR) sent by the PCF.

In S506, the SMF sends the QoS parameter to the UPF, so that the UPF performs a QoS update on the uplink and/or downlink session QoS flow.

It should be understood that when executing S401, the PCF may send the session-AMBR to the SMF, and the SMF sends the session-AMBR to the UPF, so that the UPF performs QoS update on the uplink and/or downlink session QoS flow.

It should be noted that the execution processes of S505 to S506 may refer to the description of S401 in the examples of FIG. 2 and FIG. 4, which are not described here.

In the above process, if S202 is a QoS update process, the QoS parameter received by the SMF in S505 may be an updated QoS parameter.

So far, through the above process, in the first scenario, the SMF completes the process of performing the QoS update according to the UE status information.

In some examples, for the second scenario, FIG. 5B is a schematic flowchart illustrating an implementation of a third QoS flow control method according to an example of the present disclosure. Referring to FIG. 5B, after S501, the SMF may further execute S507, which is not shown in FIG. 5B.

In S507, the SMF performs a QoS update on the QoS flow according to the UE status information.

It should be understood that in the second scenario, since the communication system is not deployed with a PCF, the control policy of the QoS flow may be decided by the SMF side. After receiving the UE status information of the UE, the SMF may perform the static rule activation and the QoS authorization update according to the power consumption state of the UE.

In the present disclosure, the terminal status information of the terminal is provided to the first core network function entity (such as PCF) through the second core network function entity (that is, SMF entity), so that the first core network function entity can match the service flow characteristics and the terminal power consumption management according to the terminal status information, that is, control the QoS flows according to the power consumption state of the terminal, so as to ensure service requirements and user experience.

Based on the same inventive concept, an example of the present disclosure provides an apparatus for controlling a QoS flow, and FIG. 6 is a schematic structural diagram of a QoS flow control apparatus according to an example of the present disclosure. As shown in FIG. 6, the control apparatus 600 may include a processing module 601, a receiving module 602, and a sending module 603.

In some examples, the control apparatus 600 may be a first core network function entity (such as a PCF) in a communication system, or a chip of the first core network function entity or a system on chip in the communication system, or may be a functional module in the first core network function entity for performing the method described in each of the above examples. The control apparatus 600 may implement the functions performed by the first core network function entity in the above examples, and these functions may be implemented by a hardware executing a corresponding software. The hardware or software includes one or more modules corresponding to the functions described above.

Correspondingly, the receiving module 602 is configured to receive terminal status information from a second core network function entity, where the terminal status information indicates the power consumption status of a terminal; and the processing module 601 is configured to perform a QoS update on a QoS flow according to the terminal status information.

In the present disclosure, the first core network function entity may be a PCF, and the second core network function entity may be an SMF.

In some examples, the QoS flow includes at least one of: a terminal QoS flow; a session QoS flow; a QoS flow of service data.

In some examples, the terminal status information includes at least one of the following: a battery level; a battery life; a powered mode; a CPU load; a terminal overheating status.

In some examples, the QoS flow is a GBR QoS flow, and a QoS parameter of the QoS flow includes a GFBR and/or an MFBR.

In some examples, the processing module 601 is configured to decrease or increase the GFBR according to the terminal status information.

In some examples, the sending module 603 is configured to send an MFBR to the third core network function entity, where the MFBR is used by the third core network function entity to perform a QoS update on a downlink GBR QoS flow; and/or send an MFBR to an access network function entity, where the MFBR is used by the access network function entity to perform a QoS update on an uplink and/or downlink GBR QoS flow.

In the present disclosure, the third core network function entity may be a UPF.

In some examples, the QoS flow is a non-GBR QoS flow, and a QoS parameter of the QoS flow includes an AMBR.

In some examples, the processing module 601 is configured to decrease or increase the AMBR according to the terminal status information.

In some examples, the AMBR includes at least one of: an AMBR per terminal, an AMBR per session.

In some examples, in response to the AMBR including an AMBR per session, the sending module 603 is configured to send the AMBR per session to a third core network function entity, where the AMBR per session is used by the third core network function entity to perform a QoS update on an uplink and/or downlink session QoS flow; or, send the AMBR per session to the terminal, where the AMBR per session is used by the terminal to perform uplink rate limitation on PDU session basis for the non-GBR QoS flow.

In some examples, in response to the AMBR including an AMBR per terminal, the sending module 603 is configured to send the AMBR per terminal to an access network function entity, where the AMBR per terminal is used by the access network function entity to perform a QoS update on an uplink and/or downlink non-GBR QoS flow of each terminal.

In some examples, the QoS flow is a GBR QoS flow or a non-GBR QoS flow, and a QoS parameter of the QoS flow includes an MBR per slice per terminal.

In some examples, in response to the QoS parameter including an MBR per slice per terminal, the sending module 603 is configured to send the MBR per slice per terminal to an access network function entity, where the MBR per slice per terminal is used by the access network function entity to perform a QoS update on a PDU session QoS flow corresponding to an S-NSSAI of the terminal.

In some examples, the sending module 603 is configured to send a subscription request message to the second core network function entity, and the subscription request message is used to request a first event associated with the terminal status information; the receiving module 602 is configured to receive the terminal status information sent by the second core network function entity in a case that the first event meets an event reporting condition.

In some examples, the control apparatus 600 may be the second core network function entity in a communication system or a chip or a system on chip of the second core network function entity in a communication system, or may be a functional module for performing the method according to each of the above examples in the second core network function entity. The control apparatus 600 may implement the functions performed by the second core network function entity according to the above examples, and these functions may be implemented by a hardware executing a corresponding software. The hardware or software includes one or more modules corresponding to the functions described above.

Correspondingly, the receiving module 602 is configured to receive terminal status information from a terminal, where the terminal status information indicates a power consumption state of the terminal; and the processing module 601 is configured to perform a QoS update on a QoS flow according to the terminal status information; the sending module 603 is configured to send the terminal status information to the first core network function entity, where the terminal status information is further used by the first core network function entity to determine a QoS parameter of a QoS flow.

In the present disclosure, the second core network function entity may be an SMF, and the first core network function entity is a PCF.

In some examples, the QoS flow includes at least one of: a terminal QoS flow; a session QoS flow; and a QoS flow of service data.

In some examples, the terminal status information includes at least one of the following: a battery level; a battery life; a powered mode; a CPU load; a terminal overheating status.

In some examples, the QoS flow is a GBR QoS flow, and the QoS parameter of the QoS flow includes a GFBR and/or an MFBR.

In some examples, in response to the QoS parameter including the MFBR, the receiving module 602 is configured to receive an MFBR sent by the first core network function entity; the sending module 603 is configured to send the MFBR to a third core network function entity, and the MFBR is used by the third core network function entity to perform a QoS update on a downlink GBR QoS flow.

In the present disclosure, the third core network function entity may be a UPF.

In some examples, the QoS flow is a non-GBR QoS flow, and the QoS parameter of the QoS flow includes an AMBR.

In some examples, the AMBR includes at least one of: an AMBR per terminal, an AMBR per session.

In some examples, in response to the AMBR including an AMBR per session, the receiving module 602 is configured to receive an AMBR per session sent by the first core network function entity; the sending module 603 is configured to send the AMBR per session to a third core network function entity, where the AMBR per session is used by the third core network function entity to perform a QoS update on an uplink and/or downlink session QoS flow.

In some examples, the receiving module 602 is configured to receive terminal status information sent by a terminal, where the terminal status information is carried in an NAS parameter.

In some examples, the terminal status information is carried in a PCO parameter or a parameter of UE 5GSM Core Network Capability.

In some examples, the receiving module 602 is configured to receive the terminal status information sent by an access network function entity, where the terminal status information is extracted from an AN parameter and added to an NAS parameter by the access network function entity.

In some examples, the processing module 601 is configured to perform static rule activation and QoS authorization update based on the QoS parameter.

In some examples, the processing module 601 is configured to query event subscriptions and confirm that a first event associated with the terminal status information is subscribed to; the sending module 603 is configured to send the terminal status information to the first core network function entity when an event reporting condition is met.

In some examples, the sending module 603 is configured to send the terminal status information to the first core network function entity according to subscription data of the terminal and/or an operator policy.

It should be noted that, the specific implementation processes of the processing module 601, the receiving module 602 and the sending module 603 can refer to the detailed descriptions of the examples of FIG. 2 to FIG. 5B, which are not described here for brevity.

The receiving module 602 mentioned in the example of the present disclosure may be a receiving interface, a receiving circuit, or a receiver; the sending module 603 may be a sending interface, a sending circuit, or a transmitter; and the processing module 601 may be one or more processors.

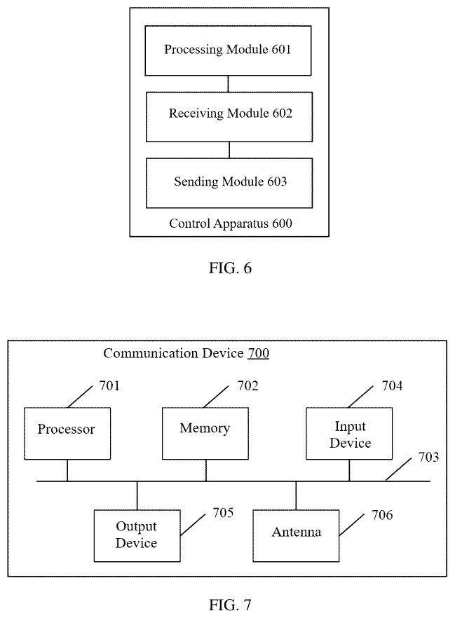

Based on the same inventive concept, an example of the present disclosure provides a communication device, which may be a first core network function entity or a second core network function entity described in one or more of the above examples. FIG. 7 is a schematic structural diagram of a communication device according to an example of the present disclosure. As shown in FIG. 7, the communication device 700 adopts general computer hardware, and includes a processor 701, a memory 702, a bus 703, an input device 704, and an output device 705.

In some examples, the memory 702 may include computer storage media in the form of volatile and/or nonvolatile memory such as read only memory and/or random access memory. The memory 702 may store operating systems, application programs, other program modules, executable code, program data, user data, and the like.

The input device 704 such as a keyboard or a pointing device, such as a mouse, trackball, touchpad, microphone, joystick, game pad, satellite dish, scanner, or the like, may be used to enter commands and information into the communication device. These input devices may be connected to the processor 701 through the bus 703.

The output device 705 may be used for a communication device to output information. In addition to a monitor, the output device 705 may also be other peripheral output devices such as a speaker and/or a printing device, which may also be connected to the processor 701 via the bus 703.

The communication device may be connected to a network, such as a local area network (LAN), through the antenna 706. In a networked environment, computer-executable instructions stored in the control device may be stored in a remote memory storage device, and is not limited to local storage.

When the processor 701 in the communication device executes the executable code or the application program stored in the memory 702, the communication device executes the QoS flow control method of the first core network function entity or the second core network function entity in the above examples. The specific execution process can refer to the above examples, and the details are not repeated here.

The memory 702 stores computer executable instructions for implementing the functions of the processing module 601, the receiving module 602, and the transmitting module 603 in FIG. 6. The functions/implementation processes of the processing module 601, the receiving module 602, and the sending module 603 in FIG. 6 may all be implemented by the processor 701 in FIG. 7 calling the computer-executable instructions stored in the memory 702, and the specific implementation processes and functions can refer to in the related examples above.

Based on the same inventive concept, an example of the present disclosure provides a network function entity, such as a first core network function entity or a second core network function entity.

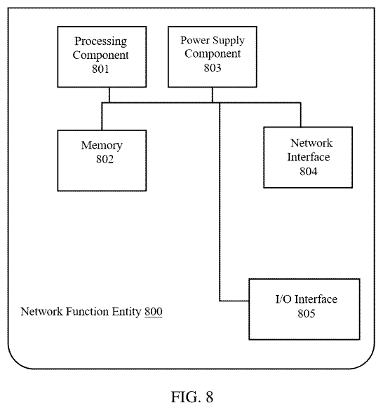

FIG. 8 is a schematic structural diagram of a network function entity according to an example of the present disclosure. As shown in FIG. 8, the network function entity 800 may include a processing component 801 which further includes one or more processors, and a memory resource represented by a memory 802 for storing instructions executable by the processing component 801, such as an application program. The application stored in the memory 802 may include one or more modules that each corresponds to a set of instructions. Additionally, the processing component 801 is configured to execute the instructions to perform any of the aforementioned methods as applied to the network devices.

The network function entity 800 may further include a power supply component 803 configured to perform power management of the network function entity 800, a wired or wireless network interface 804 configured to connect the network function entity 800 to a network, and an input/output (I/O) interface 805. The network function 800 may operate based on an operating system stored in the memory 802, such as Windows Server ™, Mac OS X™, Unix™, Linux™, FreeBSD™, or the like.

Based on the same inventive concept, the example of the present disclosure also provides a communication device, such as a first core network function entity, including a memory and a processor, where the processor is connected with the memory and configured to perform the QoS flow control method of the first core network function entity side according to the one or more examples by executing computer-executable instructions stored in the memory.

Based on the same inventive concept, the example of the present disclosure also provides a communication device, such as a second core network function entity, including a memory and a processor, where the processor is connected with the memory and configured to perform the QoS flow control method of the second core network function entity side according to the one or more examples by executing the computer-executable instructions stored in the memory.

On the basis of the same inventive concept, an example of the present disclosure further provides a computer-readable storage medium, where the computer-readable storage medium stores instructions, and when the instructions are executed on a computer, the computer is caused to perform the QoS flow control method of a network function entity side according to the one or more examples. Here, the network function entity may include the first core network function entity or the second core network function entity.

On the basis of the same inventive concept, an example of the present disclosure further provides a computer program or a computer program product, when the computer program product is executed on a computer, the computer is caused to perform a QoS flow control method of a network function entity side according to the one or more examples. The network function entity may include the first core network function entity or the second core network function entity.

Other examples of the present disclosure will occur to those skilled in the art upon consideration of the specification and practice of the disclosure herein. This disclosure is intended to cover any variations, uses, or adaptations of the disclosure following the general principles of the disclosure and including common general knowledge or customary technical means in the art not disclosed in this disclosure. It is intended that the specification and examples be considered as for examples only, with a true scope and spirit of the disclosure being indicated by the following claims.

It is to be understood that the invention is not limited to the precise constructions which have been described above and illustrated in the accompanying drawings and that various modifications and changes may be made therein without departing from the scope of the present disclosure. The scope of the present disclosure is limited only by the appended claims.

1. A Quality of Service (QoS) flow control method, comprising:
receiving, by a first core network function entity, terminal status information from a second core network function entity, wherein the terminal status information indicates a power consumption state of a terminal; and
updating, by the first core network function entity, a QoS parameter of a QoS flow according to the terminal status information.

2. (canceled)

3. (canceled)

4. The method of claim 1, wherein the QoS flow is a guaranteed bit rate (GBR) QoS flow, and the QoS parameter of the QoS flow comprises at least one of a guaranteed flow bit rate (GFBR) or a maximum flow bit rate (MFBR);
wherein the updating, by the first core network function entity, the QoS parameter of the QoS flow according to the terminal status information comprises:
decreasing or increasing, by the first core network function entity, the GFBR according to the terminal status information.

5. (canceled)

6. The method of claim 4, wherein the method further comprises at least one of:
sending, by the first core network function entity, an MFBR to a third core network function entity, wherein the MFBR is used by the third core network function entity to update a QoS parameter of a downlink GBR QoS flow; or
sending, by the first core network function entity, an MFBR to an access network function entity, wherein the MFBR is used by the access network function entity to update a QoS parameter of at least one of an uplink GBR QoS flow or a downlink GBR QoS flow.

7. The method of claim 1, wherein the QoS flow is a non-guaranteed bit rate (non-GBR) QoS flow, and the QoS parameter of the QoS flow comprises an aggregated maximum bit rate (AMBR);
wherein the updating, by the first core network function entity, the QoS parameter of the QoS flow according to the terminal status information comprises:
decreasing or increasing, by the first core network function entity, the AMBR according to the terminal status information.

8. (canceled)

9. The method of claim 7, wherein the AMBR comprises at least one of: an AMBR per terminal, or an AMBR per session, and
the method further comprises at least one of:
sending, by the first core network function entity, an AMBR per session to a third core network function entity, wherein the AMBR per session is used by the third core network function entity to update a QoS parameter of at least one of an uplink session QoS flow or a downlink session QoS flow;
sending, by the first core network function entity, the AMBR per session to the terminal, wherein the AMBR per session is used by the terminal to perform uplink rate limitation on packet data unit (PDU) session basis for the non-GBR QoS flow; or
sending, by the first core network function entity, an AMBR per terminal to an access network function entity, wherein the AMBR per terminal is used by the access network function entity to update a QoS parameter of at least one of an uplink non-GBR QoS flow or a downlink non-GBR QoS flow of each terminal.

10. (canceled)

11. (canceled)

12. The method of claim 1, wherein the QoS flow is a guaranteed bit rate (GBR) QoS flow or a non-GBR QoS flow, and the QoS parameter of the QoS flow comprises a maximum bit rate (MBR) per slice per terminal,
wherein in response to the QoS parameter comprising an MBR per slice per terminal, the method further comprises:
sending, by the first core network function entity, the MBR per slice per terminal to an access network function entity, wherein the MBR per slice per terminal is used by the access network function entity to update a QoS parameter of a packet data unit (PDU) session QoS flow corresponding to a single network slice selection assistance information (S-NSSAI) of the terminal.

13. (canceled)

14. The method of claim 1, wherein the receiving, by the first core network function entity, the terminal status information from the second core network function entity comprises:
sending, by the first core network function entity, a subscription request message to the second core network function entity, wherein the subscription request message is used to request a first event associated with the terminal status information; and
in a case that the first event meets an event reporting condition, receiving, by the first core network function entity, the terminal status information sent by the second core network function entity.

15. A Quality of Service (QoS) flow control method, comprising:
receiving, by a second core network function entity, terminal status information from a terminal, wherein the terminal status information indicates a power consumption state of the terminal;
performing, by the second core network function entity, one of:
updating, by the second core network function entity, a QoS parameter of a QoS flow according to the terminal status information; or
sending, by the second core network function entity, the terminal status information to a first core network function entity, wherein the terminal status information is further used by the first core network function entity to determine the QoS parameter of the QoS flow.

16. (canceled)

17. (canceled)

18. The method of claim 15, wherein the QoS flow is a GBR QoS flow, and the QoS parameter of the QoS flow comprises at least one of a guaranteed flow bit rate (GFBR) or a maximum flow bit rate (MFBR);
wherein in response to the QoS parameter comprising the MFBR, the method further comprises:
receiving, by the second core network function entity, an MFBR sent by the first core network function entity; and
sending, by the second core network function entity, the MFBR to a third core network function entity, wherein the MFBR is used by the third core network function entity to update a QoS parameter of a downlink GBR QoS flow.

19. (canceled)

20. The method of claim 15, wherein the QoS flow is a non-guaranteed bit rate (non-GBR) QoS flow and the QoS parameter of the QoS flow comprises an aggregated maximum bit rate (AMBR);
wherein the AMBR comprises at least one of: an AMBR per terminal, or an AMBR per session,
wherein in response to the AMBR comprising an AMBR per session, the method further comprises:
receiving, by the second core network function entity, an AMBR per session sent by the first core network function entity; and
sending, by the second core network function entity, the AMBR per session to a third core network function entity, wherein the AMBR per session is used by the third core network function entity to update a QoS parameter of at least one of an uplink session QoS flow or a downlink session QoS flow.

21. (canceled)

22. (canceled)

23. The method of claim 15, wherein the receiving, by a second core network function entity, terminal status information comprises:
receiving, by the second core network function entity, the terminal status information sent by the terminal, wherein the terminal status information is carried in a non-access stratum (NAS) parameter,
wherein the terminal status information is carried in a protocol configuration option (PCO) parameter or a parameter of 5GSM core network capability of the terminal.

24. (canceled)

25. The method of claim 15, wherein the receiving, by a second core network function entity, terminal status information comprises:
receiving, by the second core network function entity, the terminal status information sent by an access network function entity, wherein the terminal status information is extracted from an access network (AN) parameter and added to a non-access stratum (NAS) parameter by the access network function entity.

26. The method of claim 15, wherein the method further comprises:
performing, by the second core network function entity, static rule activation and QoS authorization update according to the QoS parameter.

27. The method of claim 15, wherein the sending, by the second core network function entity, the terminal status information to the first core network function entity comprises one of:
querying, by the second core network function entity, event subscriptions, and confirming that a first event associated with the terminal status information is subscribed to; and in a case that an event reporting condition is met, sending, by the second core network function entity, the terminal status information to the first core network function entity; or
sending, by the second core network function entity, the terminal status information to the first core network function entity according to at least one of subscription data of the terminal or an operator policy.

28-30. (canceled)

31. A communication device operating as a first core network function entity, comprising:
a memory; and
a processor connected to the memory and configured to:
receive terminal status information from a second core network function entity, wherein the terminal status information indicates a power consumption state of a terminal;
update a Quality of Service (QoS) parameter of a QoS flow according to the terminal status information.

32. A non-transitory computer storage medium storing computer-executable instructions that, when executed by a processor, cause the processor to perform the QoS flow control method according to claim 1.

33. The communication device of claim 31, wherein the QoS flow is a guaranteed bit rate (GBR) QoS flow, and the QoS parameter of the QoS flow comprises at least one of a guaranteed flow bit rate (GFBR) or a maximum flow bit rate (MFBR), and
the processor is further configured to:
decrease or increase the GFBR according to the terminal status information.

34. The communication device of claim 33, wherein the processor is further configured to perform at least one of:
sending an MFBR to a third core network function entity, wherein the MFBR is used by the third core network function entity to update a QoS parameter of a downlink GBR QoS flow; or
sending an MFBR to an access network function entity, wherein the MFBR is used by the access network function entity to update a QoS parameter of at least one of an uplink GBR QoS flow or a downlink GBR QoS flow.

35. The communication device of claim 31, wherein the QoS flow is a non-guaranteed bit rate (non-GBR) QoS flow, and a QoS parameter of the QoS flow comprises an aggregated maximum bit rate (AMBR), and
the processor is further configured to:
decrease or increase the AMBR according to the terminal status information.

36. The communication device of claim 35, wherein the AMBR comprises at least one of: an AMBR per terminal, or an AMBR per session, and
the processor is further configured to perform at least one of:
sending an AMBR per session to a third core network function entity, wherein the AMBR per session is used by the third core network function entity to update a QoS parameter of at least one of an uplink session QoS flow or a downlink session QoS flow;
sending the AMBR per session to the terminal, wherein the AMBR per session is used by the terminal to perform uplink rate limitation on packet data unit (PDU) session basis for the non-GBR QoS flow; or
sending an AMBR per terminal to an access network function entity, wherein the AMBR per terminal is used by the access network function entity to update a QoS parameter of at least one of an uplink non-GBR QoS flow or a downlink non-GBR QoS flow of each terminal.
